(19) United States
(12) Patent Application Publication
(10) Pub. No.: US 2025/0303328 A1
(43) Pub. Date: Oct. 2, 2025

(54) IMPREGNATED FILTER MEDIUM

(71) Applicant: Neenah Gessner GmbH, Bruckmühl (DE)

(72) Inventors: Werner HÖRL, Bruckmühl (DE); Fabian FRITZE, Bruckmühl (DE)

(21) Appl. No.: 19/087,673

(22) Filed: Mar. 24, 2025

(30) Foreign Application Priority Data
Mar. 27, 2024 (EP) 24167003.3

(51) Int. Cl. B01D 39/04; B01D 29/00; B01D 29/01; B01D 46/00

(52) U.S. Cl. CPC B01D 39/04; B01D 29/0093; B01D 29/016; B01D 46/0002; B01D 2239/0464; B01D 2239/10

(57) ABSTRACT

A filter medium, filtration device, and methods for the same are described. The filter medium may include a base impregnated with a cured epoxy resin. The cured epoxy resin may be the reaction product of, or formed by, the reaction of an epoxy resin and a curing agent. The epoxy resin may include a diglycidyl ether. The diglycidyl ether may be the reaction product of or formed by the reaction of a diol and an epihalohydrin. The epihalohydrin may be derived from one or more renewable sources. The method may include impregnating a base filter medium with an impregnation composition including one or more of an epoxy resin, a curing agent, a solvent, or a combination thereof. The method may also include reacting the epoxy resin with the curing agent to form a cured epoxy resin.

### CROSS-REFERENCE TO RELATED APPLICATIONS

This application claims priority to European Patent Application No. 24167003.3, filed 27 Mar. 2024, the complete disclosure of which is incorporated herein by reference for all purposes.

### TECHNICAL FIELD

The present description relates to filter media and methods of making filter media from renewable sources.

### BACKGROUND

Filtration systems have uses in many fields. They are typically used to remove undesirable materials from a fluid (e.g., a liquid or gas) by passing the fluid through a filter medium. A filter medium has a number of different properties including thickness, basis weight, dust holding capacity, filter efficiency, permeability, pore size, and mechanical properties, such as burst strength, tensile strength, and elongation at break. It is often desirable to improve one property of a filter medium so that it is particularly suited to a use in a particular filtration process or system. However, improving any property of the filter medium may adversely affect one or more of the other properties.

In most filtration systems, the filter medium is a consumable part of the system as long-term use of a filter medium generally reduces its effectiveness at removing undesirable materials from a fluid. Indeed, a filter medium used for depth filtration contains torturous pathways through the filter medium that retain particles of the undesirable material within the filter medium. Thus, a depth filtration filter medium must be replaced periodically because the pores within the filter medium become blocked over time reducing fluid flow through the filtration system. While filter media used in surface filtration tend to have a longer useable lifespan (because the undesirable particles are trapped at the surface of the filter medium, allowing periodic cleaning of the filter medium to remove the particles), these filter media still need to be replaced periodically.

Unfortunately, many of the components of filter media are produced from fossil fuels. In particular, the polymeric resins used to impregnate the base filter medium are generally produced from fossil fuels. In view of the consumable nature of filter media, the use of fossil fuels to produce filter media is undesirable.

WO 2022/008614 discloses filtration media comprising a fibrous web impregnated with a resin composition comprising lignin. The fibrous web comprises the lignin in an amount of from 0.1 to 30 wt. % by weight of the fibrous web; and the lignin has a density of less than 1.2 g/cm or a weight average molecular weight of less than 20000 g/mol when measured according to ASTM D4001-13 standard. While the filtration medium described in WO 2022/008614 involves impregnation with a resin composition that can be produced from renewable sources, the resin composition does not provide a filtration medium with suitable properties for use in all filtration systems.

Although this filter medium allows the environmental impact of replacing certain filter media to be reduced, it cannot be used in all filtration systems. Consequently, it is desirable to produce other filter media that maintain or improve the properties of current filter media whilst also reducing the environmental impact of replacing the filter medium within the system.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

In one aspect, a filter medium comprises a base impregnated with a cured epoxy resin. The cured epoxy resin may be formed by the reaction of an epoxy resin with a curing agent. The epoxy resin may include a diglycidyl ether formed by the reaction of a diol with an epihalohydrin. The epihalohydrin may be derived from one or more renewable source.

The proportion of carbon from renewable sources can be increased by impregnating the base filter medium with an epoxy resin of the type described herein without detrimentally affecting the filtration properties of the filter medium. Indeed, in such filter media the dry and wet bursting strength, dry and wet stiffness, elongation at break and chemical resistance to filtration fluids are not detrimentally affected by the resin described herein. Moreover, epoxy resins are hydrophobic and may not require additional steps to cure the resin.

In embodiments, the diol may be one or more of bisphenol A, bisphenol F, or a mixture thereof.

In embodiments, the epihalohydrin may be or include epichlorohydrin.

In embodiments, the epoxy resin may include a biobased carbon content of at least about 20 wt %.

In embodiments, the epoxy resin may include a biobased carbon content of from about 25 wt % to about 45 wt %.

In embodiments, the curing agent may include one or more of poly(amido amine), poly(amidoimidazoline)amine, or a combination thereof.

In embodiments, the base filter medium may include a paper substrate.

In embodiments, the base filter medium may include cellulose fibers.

In embodiments, the diglycidyl ether may be one or more of bisphenol A diglycidyl ether, bisphenol F diglycidyl ether, or a mixture thereof.

In another aspect, a filtration device comprises a filter medium. The filter medium may include a base impregnated with a cured epoxy resin. The cured epoxy resin may be formed by the reaction of an epoxy resin with a curing agent. The epoxy resin may include a diglycidyl ether formed by the reaction of a diol with an epihalohydrin. The epihalohydrin may be derived from one or more renewable source.

In embodiments, the diol may be one or more of bisphenol A, bisphenol F, or a mixture thereof.

In embodiments, the epihalohydrin may be or include epichlorohydrin.

In embodiments, the epoxy resin may include a biobased carbon content of at least about 20 wt %.

In embodiments, the epoxy resin may include a biobased carbon content of from about 25 wt % to about 45 wt %.

In embodiments, the curing agent may include one or more of poly(amido amine), poly(amidoimidazoline)amine, or a combination thereof.

In embodiments, the base filter medium may include a paper substrate.

In embodiments, the base filter medium may include cellulose fibers.

In one aspect, the diglycidyl ether may be one or more of bisphenol A diglycidyl ether, bisphenol F diglycidyl ether, or a mixture thereof.

In another aspect, an air intake filtration device for automotive air filtration comprises the filter medium described herein. In another aspect, the air intake filtration device may include the air filtration device described herein.

In another aspect, a method for producing a filter medium comprises impregnating a base filter medium with an epoxy resin and a curing agent. The method may also include reacting the epoxy resin with the curing agent to form a cured epoxy resin. The epoxy resin may include a diglycidyl ether formed by the reaction of a diol with an epihalohydrin. The epihalohydrin mya be derived from a renewable source.

In embodiments, the method may further include reacting the diol with the epihalohydrin to form the epoxy resin.

In embodiments, the method may include producing the epihalohydrin from one or more of rapeseed oil, coconut fat, olive oil, palm oil, sunflower oil, animal fat, or a combination thereof.

In embodiments, the method may include contacting the epoxy resin, the curing agent, and a solvent to form an impregnation composition and contacting the base filter medium with the impregnation composition.

In another aspect, there is provided a filtration device. The filtration device comprises the filter medium described herein. In some examples, the filtration device may comprise or be a gas filter, an air intake filter, or a liquid filter, such as a lube oil filter, fuel filter or hydraulic filter.

In a further aspect, there is provided an air intake filtration device for automotive air filtration comprising a filter medium described herein.

In another aspect, there is provided a method of producing a filter medium. The method of producing a filter medium comprises impregnating a base filter medium with an epoxy resin and a curing agent; and reacting the epoxy resin with the curing agent to form a cured epoxy resin. The epoxy resin may be any epoxy resin described herein. For example, the epoxy resin comprises a diglycidyl ether formed by the reaction of a diol with an epihalohydrin; the epihalohydrin derived from renewable sources.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Additionally, all numerical values are “about” or “approximately” the indicated value, and take into account experimental error and variations that would be expected by a person having ordinary skill in the art. It should be appreciated that all numerals, numerical values, and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically disclosed.

As used herein, the expression “free” of a material or substance may refer to a composition, component, or phase where the material is present in an amount of less than 1.0 wt %, less than 0.1 wt %, less than 0.05 wt %, less than 0.01 wt %, less than 0.005 wt %, or less than 0.0001 wt %, based on a total weight of the composition, component, or phase. As used herein, the expression “substantially free” of a material or substance may refer to a composition, component, or phase where the material is present in an amount of from about 1.0 wt % or more to less than 20.0 wt %, less than 10.0 wt %, less than 5.0 wt %, less than 3.0 wt %, less than 2.0 wt %, less than 1.8 wt %, or less than 1.5 wt %.

All references cited herein are hereby incorporated by reference in their entireties. In the event of a conflict in a definition with a cited reference, the present teachings control.

As used herein, “co-polymer” refers to a polymer that is polymerized from at least two monomers.

If a standard test is mentioned herein, unless otherwise stated, the version of the test to be referred to is the most recent at the time of filing this patent application.

As used herein, “NVS” is an abbreviation of the term “non-volatile solids”.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of the composition, and including the weight of any fluid present.

Unless otherwise stated, any feature described herein can be combined with any aspect or any other feature described herein.

The present inventors have surprisingly and unexpectedly discovered that the proportion and/or ratio of carbon from renewable sources can be increased by impregnating a base filter medium with an epoxy resin of the type described herein without detrimentally affecting the filtration properties of the filter medium. Indeed, in such filter media the dry and wet bursting strength, dry and wet stiffness, elongation at break, and/or chemical resistance to filtration fluids are not detrimentally affected by the epoxy resin described herein. Moreover, the epoxy resins are hydrophobic and may not require additional steps to cure the resins.

### Filter Medium

In an aspect, there is described a filter medium. The filter medium may comprise a base filter medium impregnated with a cured epoxy resin formed by the reaction of an epoxy resin with a curing agent, wherein the epoxy resin may comprise a diglycidyl ether formed by the reaction of a diol with an epihalohydrin; and wherein at least the epihalohydrin may be derived from renewable sources.

The base filter medium impregnated with the cured epoxy resin may be referred to herein as a saturated filter medium. In some examples, the filter medium may comprise at least about 5 wt. % cured epoxy resin based on the total weight of the saturated filter medium, for example, at least about 10 wt. %, at least about 15 wt. %, at least about 20 wt. %, at least about 25 wt. %, at least about 30 wt. %, or at least about 35 wt. % cured epoxy resin based on the total weight of the saturated filter medium. In some examples, the filter medium may comprise up to about 35 wt. % cured epoxy resin based on the total weight of the saturated filter medium, for example, up to about 30 wt. %, up to about 25 wt. %, up to about 20 wt. %, up to about 15 wt. %, up to about 10 wt. %, or up to about 5 wt. % cured epoxy resin based on the total weight of the saturated filter medium. In some examples, the filter medium may comprise from about 5 wt. % to about 35 wt. % cured epoxy resin based on the total weight of the saturated filter medium, for example, from about 10 wt. % to about 30 wt. %, about 15 wt. % to about 25 wt. %, or about 20 wt. % to about 25 wt. % cured epoxy resin based on the total weight of the saturated filter medium.

In some examples, the filter medium may comprise at least about 65 wt. % base filter medium based on the total weight of the saturated filter medium, for example, at least about 70 wt. %, at least about 75 wt. %, at least about 80 wt. %, at least about 85 wt. %, at least about 90 wt. %, or at least about 95 wt. % base filter medium based on the total weight of the saturated filter medium. In some examples, the filter medium may comprise at least about up to about 95 wt. % base filter medium based on the total weight of the saturated filter medium, for example, up to about 90 wt. %, up to about 85 wt. %, up to about 80 wt. %, up to about 75 wt. %, up to about 70 wt. %, or up to about 65 wt. % wt. % base filter medium based on the total weight of the saturated filter medium. In some examples, the filter medium may comprise from about 65 wt. % to about 95 wt. % base filter medium based on the total weight of the saturated filter medium, for example, from about 70 wt. % to about 90 wt. %, about 75 wt. % to about 85 wt. %, or about 80 wt. % to about 85 wt. % base filter medium based on the total weight of the saturated filter medium.

In some examples, the base filter medium may comprise a first surface and a second surface, the first surface opposing the second surface. In some examples, the first surface of the base filter medium and the second surface of the base filter medium may be impregnated with the cured epoxy resin. In some examples, the cured epoxy resin may be impregnated throughout the base filter medium.

In some examples, the filter medium may comprise a base filter medium impregnated with a cured epoxy resin. The cured epoxy resin may be formed by the reaction of the epoxy resin with the curing agent. For example, the cured epoxy resin may be the reaction product of the epoxy resin and the curing agent. The cured epoxy resin may comprise a cross-linked matrix formed by the reaction of the epoxy resin with the curing agent. In some examples, the epoxy resin may be any epoxy resin described herein and the curing agent may be any curing agent described herein.

### Epoxy Resin

The epoxy resin may comprise a diglycidyl ether formed by the reaction of a diol with an epihalohydrin, wherein the epihalohydrin may be derived from one or more renewable sources. In some examples, the epoxy resin may comprise a polymeric diglycidyl ether. The epoxy resin may comprise a diglycidyl ether terminated polyol.

In some examples, the diglycidyl ether may be an aliphatic diglycidyl ether, an aromatic diglycidyl ether, or a combination thereof. In some examples, the diglycidyl ether may be an aromatic diglycidyl ether.

In some examples, the epoxy resin may comprise or consists of a diglycidyl ether with formula (I):

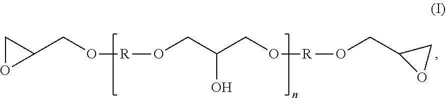

wherein each R may be independently selected from alkylene functional groups, arylene functional groups, alkarylene functional groups, aralkylene functional groups, arylene-alkylene-arylene functional groups, or a combination thereof. In some examples, R may be an arylene-alkylene-arylene functional group. In some examples, R may be selected from -Ph-C(CH₃)₂-Ph-, -Ph-C(CH₃)(Ph)-Ph-, -Ph-C(CF₃)₂-Ph, -Ph-C(CH₃)(CH₂CH₃)-Ph-, -Ph-C(Ph)₂-Ph-, -Ph (CH₃)—C(CH₃)₂-Ph (CH₃)—, -Ph-CH(CH₃)-Ph-, -Ph-CH₂-Ph-, or a combination thereof. In some examples, each R may be the same or different. In some examples, each R may be the same. In some examples, R may be -Ph-C(CH₃)₂-Ph-, -Ph-CH₂-Ph- or a combination thereof. In some examples, R may be -Ph-C(CH₃)₂-Ph-.

In some examples, n may be an integer of from 0 to 5, for example, 1, 2, 3, 4 or 5. In some examples, n may preferably be 1, 2 or 3. In some examples, n may preferably be 2 or 3. In some examples, the epoxy resin may comprise a mixture of compounds in which n may be, for example, 2 and 3. In some examples, the epoxy resin may comprise a mixture of compounds with different molecular weights due to different numbers of repeating units such that the average value of n may not be an integer.

In some examples, the epoxy resin may comprise or consists of a diglycidyl ether with formula (II):

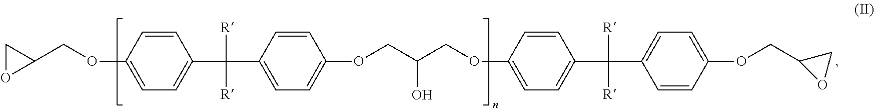

wherein each R′ may be independently selected from hydrogen, alkyl (e.g., C1 to C6 alkyl), aryl (e.g., phenyl), or a combination thereof. In some examples, each R′ may be hydrogen or alkyl (e.g., C1 to C6 alkyl). In some examples, each R′ may be hydrogen or methyl. In some examples, each R′ may be methyl.

In some examples, the diglycidyl ether may be a bisphenol diglycidyl ether, for example, bisphenol A diglycidyl ether or bisphenol F diglycidyl ether or a mixture thereof. In some examples, the diglycidyl ether may be bisphenol A diglycidyl ether. In some examples, the epoxy resin may be bisphenol A diglycidyl ether.

In some examples, the epoxy resin may have a weight average molecular weight of up to about 1000 g/mol, for example, up to about 950 g/mol, up to about 900 g/mol, up to about 850 g/mol, up to about 800 g/mol, up to about 700 g/mol. In some examples, the epoxy resin epoxy resin may have a molecular weight of from about 300 g/mol to about 1000 g/mol, for example, from about 300 g/mol to about 750 g/mol, or about 320 g/mol to about 700 g/mol.

The epoxy resin may comprise a diglycidyl ether formed by the reaction of a diol with an epihalohydrin. In some examples, the epoxy resin may be formed by the reaction of a diol with an epihalohydrin. The epihalohydrin may be derived from renewable sources. As used herein, renewable sources may refer to sources that are produced by natural processes at a rate comparable to their rate of consumption (e.g., within a 100 year time frame). Renewable sources may also refer to a natural resource that is replenished naturally on a human timescale. Renewable sources may regenerate through natural processes. Non-limiting examples of renewable sources include biomasses, plants, animals, fish, bacteria, fungi, or the like, or any combination thereof. In some examples, the renewable source may be a plant product, such as a plant-based oil (e.g., sunflower oil, rapeseed oil, coconut oil/fat, palm oil, vegetable oil, or olive oil). In some examples, the renewable source may be animal fat. In some examples, the renewable source may be a naturally occurring organism, a selectively bred organism or a genetically engineered organism. Natural resources such as fossil fuels, crude oil, petroleum, natural gas, coal and peat are examples of non-renewable resources (i.e., sources that take longer than 100 years to form).

In some examples, the epoxy resin may have a biobased carbon content of at least about 20 wt. %, for examples, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, at least about 30 wt. %, at least about 31 wt. %, at least about 32 wt. %, at least about 33 wt. %, at least about 34 wt. %, or at least about 35 wt. %. In some examples, the epoxy resin may have a biobased carbon content of up to about 45 wt. %, for example, up to about 44 wt. %, up to about 43 wt. %, up to about 42 wt. %, up to about 41 wt. %, up to about 40 wt. %, up to about 39 wt. %, up to about 38 wt. %, up to about 37 wt. %, up to about 36 wt. %, or up to about 35 wt. %. In some examples, the epoxy resin may have a biobased carbon content of from about 20 wt. % to about 45 wt. %, for example, about 21 wt. % to about 44 wt. %, about 22 wt. % to about 43 wt. %, about 23 wt. % to about 42 wt. %, about 24 wt. % to about 41 wt. %, about 25 wt. % to about 40 wt. %, about 26 wt. % to about 39 wt. %, about 27 wt. % to about 38 wt. %, about 28 wt. % to about 37 wt. %, about 29 wt. % to about 36 wt. %, or about 30 wt. % to about 35 wt. %.

The biobased carbon content may refer to the amount of biobased carbon in the material as a percentage of the weight of the total organic carbon in the product (i.e., the epoxy resin). The biobased carbon content may be determined according to ASTM 6866 of the American Society for Testing and Materials (ASTM). This test method discriminates between products resulting from contemporary carbon input and carbon derived from fossil-based carbon input. The method measures a product's 14C/12C or 14C/13C content relative to a carbon based modern reference material accepted by the radiocarbon dating community.

In some examples, the epoxy resin may have an epoxy equivalent weight of at least about 100 g/mol, for example, at least about 105 g/mol, at least about 110 g/mol, at least about 115 g/mol, at least about 120 g/mol, at least about 125 g/mol, at least about 130 g/mol, at least about 135 g/mol, at least about 140 g/mol, at least about 145 g/mol, at least about 155 g/mol, at least about 160 g/mol, at least about 165 g/mol, at least about 170 g/mol, at least about 175 g/mol, or at least about 180 g/mol. In some examples, the epoxy resin may have an epoxy equivalent weight of up to about 500 g/mol, for example, up to about 500 g/mol, up to about 475 g/mol, up to about 450 g/mol, up to about 425 g/mol, up to about 400 g/mol, up to about 375 g/mol, up to about 350 g/mol, up to about 325 g/mol, up to about 300 g/mol, up to about 275 g/mol, up to about 250 g/mol, up to about 245 g/mol, up to about 240 g/mol, up to about 235 g/mol, up to about 230 g/mol, up to about 225 g/mol, up to about 220 g/mol, up to about 215 g/mol, up to about 210 g/mol, up to about 205 g/mol, or up to about 200 g/mol. In some examples, the epoxy resin may have an epoxy equivalent weight of from about 100 g/mol to about 500 g/mol, for example, about 110 g/mol to about 490 g/mol, about 120 g/mol to about 480 g/mol, about 130 g/mol to about 470 g/mol, about 140 g/mol to about 460 g/mol, about 150 g/mol to about 450 g/mol, about 160 g/mol to about 440 g/mol, about 170 g/mol to about 430 g/mol, about 180 g/mol to about 420 g/mol, about 190 g/mol to about 410 g/mol, about 200 g/mol to about 400 g/mol, about 210 g/mol to about 390 g/mol, about 220 g/mol to about 380 g/mol, about 230 g/mol to about 370 g/mol, about 240 g/mol to about 360 g/mol, about 250 g/mol to about 350 g/mol, about 260 g/mol to about 340 g/mol, about 270 g/mol to about 330 g/mol, about 280 g/mol to about 320 g/mol, about 290 g/mol to about 310 g/mol, or about 300 g/mol to about 310 g/mol. The epoxy equivalent weight may be the number of grams of epoxy resin required to provide 1 mole of epoxy groups. In some examples, the epoxy equivalent weight may be determined by following the method described in ISO 3001:1999 of the International Organization for Standardization (ISO).

In some examples, the epoxy resin may have an epoxy index of at least about 2 mol/kg, for example, at least about 2.5 mol/kg, at least about 3 mol/kg, at least about 3.5 mol/kg, at least about 4 mol/kg, at least about 4.5 mol/kg, at least about 5 mol/kg, at least about 5.1 mol/kg, or at least about 5.2 mol/kg. In some examples, the epoxy resin may have an epoxy index of up to about 10 mol/kg, for example, up to about 8.5 mol/kg, up to about 8 mol/kg, up to about 7.5 mol/kg, up to about 7 mol/kg, up to about 6.5 mol/kg, up to about 6 mol/kg, up to about 5.9 mol/kg, up to about 5.8 mol/kg, up to about 5.7 mol/kg, up to about 5.6 mol/kg, or up to about 5.5 mol/kg. In some examples, the epoxy resin may have an epoxy index of from about 2 mol/kg to about 10 mol/kg, for example, about 2.5 mol/kg to about 9.5 mol/kg, about 3 mol/kg to about 9 mol/kg, about 3.5 mol/kg to about 8.5 mol/kg, about 4 mol/kg to about 8 mol/kg, about 4.5 mol/kg to about 7.5 mol/kg, about 5 mol/kg to about 7 mol/kg, about 5.1 mol/kg to about 6 mol/kg, or about 5.2 mol/kg to about 4.5 mol/kg. The epoxy index provides a measure of the number moles of epoxy groups in 1 kg of epoxy resin. In some examples, the epoxy index may be determined by following the method described in ISO 3001:1999 of the International Organization for Standardization (ISO). The epoxy index may be similar to the epoxy value, which provides a measure of the number of moles of epoxy groups in 100 g of epoxy resin.

### Diol

The diglycidyl ether may be formed by the reaction of any diol with an epihalohydrin. In some examples, the diol may be an aliphatic diol, an aromatic diol, or a combination thereof. In some examples, the diol may be a low molecular weight diol (e.g., with a weight average molecular weight of less than 500) or a polymeric diol.

In some examples, the diol may be selected from one or more of alkyldiols, aryldiols, alkaryldiols, aralkyldiols, aryl-alkyl-aryl diols, or any combination thereof. In some examples, the diol may be a bisphenol, for example, bisphenol A, bisphenol F or a mixture thereof. In some examples, the diol may be bisphenol A. In some examples, the diol may be any diol that produces an epoxy resin of the type described herein (e.g., as shown in formulae (I) or (II)) when reacted with an epihalohydrin.

### Epihalohydrin

The epihalohydrin may be any epihalohydrin derived from renewable sources. In some examples, the epihalohydrin may be selected from one or more of epichlorohydrin, epibromohydrin, epiiodohydrin, or a combination thereof. Preferably, the epihalohydrin may be epichlorohydrin.

In some examples, the epihalohydrin may be derived from glycerol. In some examples, the glycerol may be derived from plant, animal, fish, bacteria, fungi, or the like, or any combination thereof. In some examples, the glycerol may be derived from plant sources, for example, a plant-based oil, such as rapeseed oil, coconut fat, olive oil, palm oil and sunflower oil, or from animal sources, such as animal fats.

In some examples, the epihalohydrin may have a biobased carbon content of 100%.

### Curing Agent

In some examples, the curing agent may be any compound or substance capable of or configured to react with the epoxy resin to form a cured epoxy resin. In some examples, the curing agent may comprise an amine-containing compound (such as alkylamine compounds, cycloaliphatic amine compounds, and/or aromatic amines), an anhydride-containing compound, a polyamide-containing compound, a phenalkamine-containing compound, or a combination thereof. In some examples, the curing agent may be an alkylamine compound, a cycloaliphatic amine compound, or an aromatic amine. In some examples, the curing agent may be a polyamide, for example, a poly(amidoamine) or a poly(amidoimidazoline)amine.

In some examples, the curing agent may comprise or be an amide producible from the reaction of a multifunctional amine with a carboxylic acid. In some examples, the multifunctional amine may comprise two, three, four, five, or six amine groups. In some examples, the carboxylic acid may be a fatty acid (e.g., an aliphatic carboxylic acid containing 4 to 28 carbon atoms, for example, 10 to 28 carbon atoms, or 15 to 20 carbon atoms). In some examples, the multifunctional amine may be selected from one or more of diethylenetriamine, triethylenetetramine, pentaethylenehexamine, or any combination thereof. In some examples, the multifunctional amine may be triethylenetetramine. In some examples, the curing agent may be the reaction product of triethylenetetramine and a C15 to C20 fatty acid.

In some examples, the curing agent may comprise or be a poly(amidoimidazoline)amine.

In some examples, the curing agent may be a poly(amidoimidazoline)amine.

In some examples, the curing agent may have an amine number of at least about 300 mg KOH/g, for example, at least about 310 mg KOH/g, at least about 320 mg KOH/g, at least about mg KOH/g, at least about mg KOH/g, at least about mg KOH/g, at least about mg KOH/g, or at least about 370 mg KOH/g. In some examples, the curing agent may have an amine number of up to about 500 mg KOH/g, for example, up to about mg KOH/g, up to about 480 mg KOH/g, up to about 470 mg KOH/g, up to about 460 mg KOH/g, up to about 450 mg KOH/g, up to about 440 mg KOH/g, up to about 430 mg KOH/g, up to about 420 mg KOH/g, or up to about 410 mg KOH/g. In some examples, the curing agent may have an amine number of from about 300 mg KOH/g to about 500 mg KOH/g, for example, from about 310 mg KOH/g to about 490 mg KOH/g, about 320 mg KOH/g to about 490 mg KOH/g, about 330 mg KOH/g to about 480 mg KOH/g, about 340 mg KOH/g to about 470 mg KOH/g, about 350 mg KOH/g to about 460 mg KOH/g, about 360 mg KOH/g to about 450 mg KOH/g, about 370 mg KOH/g to about 440 mg KOH/g, about 370 mg KOH/g to about 430 mg KOH/g, about 370 mg KOH/g to about 420 mg KOH/g, or about 370 mg KOH/g to about 410 mg KOH/g. In some examples, the amine number may be measured by following the procedure described in DIN 16945 of the Deutsches Institut für Normung (DIN), which may be found in German standard titled, “Testing of resins, hardeners and accelerators, and catalyzed resins,” published in March 1989 by the Deutsches Institut für Normung (DIN).

In some examples, the curing agent may be derived from renewable sources. In some examples, the curing agent may be at least partially derived from renewable sources. In some examples, the curing agent may comprise the reaction product of an amine and a fatty acid, wherein the fatty acid may be derived from renewable sources. In some examples, the fatty acid may have a bio-based carbon content of 100%.

### Base Filter Medium

In some examples, the filter medium may comprise any base filter medium that may be capable of or configured to being impregnated with an epoxy resin. In some examples, the base filter medium may comprise a fibrous layer. In some examples, the fibrous layer may comprise a nonwoven layer. In some examples, the base filter medium may comprise a paper substrate, a spunbond nonwoven layer, a melt-blown nonwoven layer, or a combination thereof. In some examples, the base filter medium may comprise a paper substrate.

The base filter medium may comprise or consist of cellulose fibers. In some examples, the base filter medium may comprise or consist of cellulose fibers and synthetic fibers. In some examples, the synthetic fibers may be selected from polymeric fibers, inorganic fibers, or a combination thereof. In some examples, the base filter medium may comprise or consist of synthetic fibers (e.g., polymeric fibers or inorganic fibers).

In some examples, the polymeric fibers may comprise a material selected from one or more of a polyester, a polycarbonate, a polyamide, a polyaramid, a polyimide, a polyolefin, a polyether ether ketone, a polyolefin, a polyacrylic, a polyvinyl alcohol, a polyacrylonitrile, a polyvinylidene fluoride (PVDF), polylactic acid (PLA), silicone, polyether sulfone, copolymers thereof, or combinations thereof. The polyester may be selected from polyethylene terephthalate, polybutylene terephthalate, or a combination thereof. The polyamide may be a nylon. The polyolefin may be selected from polyethylene, polypropylene, or a combination thereof. In some examples, the polymeric fibers may be selected from polyester fibers, polyacrylic fibers, or combinations thereof. In some examples, the polymeric fibers may comprise polyester fibers. In some examples, the polymeric fibers may be polyethylene terephthalate fibers.

In some examples, the inorganic fibers may comprise a material selected from glass, carbon, ceramic, silica, or a combination thereof. In some examples, the inorganic fibers may comprise or consist of glass fibers.

In some examples, the base filter medium may comprise at least about 30 wt. % cellulose fibers, for example, at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 90 wt. %, or at least about 95 wt. % cellulose fibers. In some examples, the base filter medium may comprise up to about 100 wt. % cellulose fibers, for example, up to about 95 wt. %, up to about 90 wt. %, up to about 85 wt. %, up to about 80 wt. %, up to about 75 wt. %, up to about 70 wt. %, up to about 65 wt. %, up to about 60 wt. %, up to about 55 wt. %, up to about 50 wt. %, up to about 45 wt. %, up to about 40 wt. %, up to about 35 wt. %, or up to about 30 wt. % cellulose fibers. In some examples, the base filter medium may comprise from about 30 wt. % to about 100 wt. % cellulose fibers, for example, about 35 wt. % to about 100 wt. %, about 40 wt. % to about 95 wt. %, about 45 wt. % to about 90 wt. %, about 50 wt. % to about 85 wt. %, about 55 wt. % to about 80 wt. %, about 60 wt. % to about 75 wt. %, or about 65 wt. % to about 70 wt. % cellulose fibers.

In some examples, the base filter medium may comprise up to about 100 wt. % synthetic fibers, for example, up to about 70 wt. %, up to about 65 wt. %, up to about 60 wt. %, up to about 55 wt. %, up to about 50 wt. %, up to about 45 wt. %, up to about 40 wt. %, up to about 35 wt. %, up to about 30 wt. %, up to about 25 wt. %, up to about 20 wt. %, or up to about 15 wt. % synthetic fibers. In some examples, the base filter medium may comprise from about 0 wt. % to about 100 wt. % synthetic fibers, for example, about 0 wt. % to about 70 wt. %, about 5 wt. % to about 70 wt. %, about 10 wt. % to about 65 wt. %, about 15 wt. % to about 60 wt. %, about 20 wt. % to about 55 wt. %, about 25 wt. % to about 50 wt. %, about 30 wt. % to about 45 wt. %, or about 35 wt. % to about 40 wt. % synthetic fibers.

In some examples, the base filter medium may comprise up to about 100 wt. % inorganic fibers (e.g., glass fibers). In some examples, the base filter medium may comprise up to about 50 wt. % inorganic fibers (e.g., glass fibers), for example, up to about 25 wt. % inorganic fibers. In some examples, the base filter medium may comprise from about 15 wt. % to about 50 wt. % inorganic fibers (e.g., glass fibers), for example, about 15 wt. % to about 25 wt. % inorganic fibers.

In some examples, the base filter medium may comprise up to about 50 wt. % inorganic fibers (e.g., glass fibers) and up to about 20 wt. % polymeric fibers. In some examples, the remainder may be cellulose fibers. In some examples, the base filter medium may comprise about 15 wt. % to about 50 wt. %, for example, about 15 wt. % to about 25 wt. % inorganic fibers (e.g., glass fibers) and up to about 20 wt. % polymer fibers (e.g., polyester fibers). In some examples, the base filter medium may comprise cellulose fibers and polymer fibers, for example, up to about 50 wt. % polymer fibers (e.g., about 15 wt. % to about 30 wt. % polymer fibers).

In some examples, the cellulose fibers may comprise only one or multiple different types of cellulose fiber (which can also be fibrillated), for example, a combination of hardwood fibers and softwood fibers. In some examples, the cellulose fibers may comprise only one type of cellulose fiber. In some examples, the cellulose fibers may comprise multiple different types of cellulose fiber, for example, a combination of hardwood fibers and softwood fibers. In some examples, the cellulose fibers may be fibrillated. The softwood fibers may be derived from pine (e.g., longleaf pine, shortleaf pine, loblolly pine, slash pine, or Southern pine), Jack pine, balsam fir, Douglas fir, western hemlock, redwood, red cedar, northern softwood, southern softwood, hemlock, spruce (e.g., black spruce or white spruce), or the like, or any combination thereof. The softwood fibers may be from a Northern Bleached Softwood kraft (NBSK) pulp. The hardwood fibers may be derived from aspen, birch, beech, oak, maple, eucalyptus, or gum.

The relative proportion of softwood and hardwood fibers, respectively, may be selected so that the proportion (based on weight) of softwood fibers may be higher than the proportion of hardwood fibers). The relative weight to weight proportions of softwood fibers and hardwood fibers may be from about 85:15 (i.e., about 85 to about 15) to about 60:40, for example, about 80:20 to about 65:35.

### Filtration Device

In a further aspect, a filtration device is described herein. The filtration device may comprise any filter medium described herein. In some examples, the filtration device may comprise a corrugated filter medium. The corrugated filter medium may comprise or consist of any filter medium described herein that may have been corrugated.

In some examples, the filtration device may comprise a filter medium disposed within a frame. The frame may ensure that the filter medium maintains a particular shape during use of the filtration device.

The filtration device may be an air filtration device, a gas filtration device, a liquid filtration device, or an industrial filtration device. In some examples, the liquid filtration device may be a lube oil filtration device, an oil filtration device, a fuel filtration device, or a hydraulic filtration device. In some examples, the air filtration device may be a cabin air filtration device (e.g., for automotive applications), or an HVAC filtration device. In some examples, the air filtration device may be an air intake filtration device for automotive applications.

In another aspect, an air intake filtration device for automotive air filtration is described herein. The air intake filtration device for automotive air filtration may comprise a filter medium and/or a filtration device of the type described herein.

### Method of Producing a Filter Medium

In another aspect, a method of producing a filter medium is described herein. The method of producing a filter medium may comprise impregnating a base filter medium with an epoxy resin and a curing agent; and reacting the epoxy resin with the curing agent to form a cured epoxy resin, wherein the epoxy resin may comprise a diglycidyl ether formed by the reaction of a diol with an epihalohydrin; and wherein the epihalohydrin may be derived from renewable sources.

In some examples, the base filter medium may be impregnated with the epoxy resin and the curing agent by contacting the base filter medium with an impregnation composition. The impregnation composition may comprise the epoxy resin and the curing agent. In some examples, the impregnation composition may additionally comprise a solvent (e.g., polar solvent), for example, an alcohol solvent (e.g., methanol), acetone or water. In some examples, the impregnation composition may comprise additional additives, for example, additives to modify the physical properties of the filter medium, such as hydrophobicity agents, hydrophilicity agents, accelerator agents, dye pigments, reactive diluents, or the like, or any combination thereof.

In some examples, the method may comprise combining the epoxy resin, the curing agent, and a solvent (and optionally the additionally additive or additives) to form an impregnation composition, and contacting the base filter medium with the impregnation composition. In some examples, the method may comprise combining the epoxy resin with a solvent and then adding the curing agent to form the impregnation composition and then contacting the base filter medium with the impregnation composition. In some examples, the method may comprise combining the curing agent with a solvent and then adding the epoxy resin to form the impregnation composition and then contacting the base filter medium with the impregnation composition.

In some examples, the impregnation composition may comprise at least about 50 wt. % solvent, for example, at least about 55 wt. %, at least about 60 wt. %, at least about 65 wt. %, at least about 70 wt. % solvent, at least about 75 wt. %, or at least about 80 wt. % solvent. In some examples, the impregnation composition may comprise up to about 95 wt. % solvent, for example, up to about 90 wt. %, up to about 85 wt. %, up to about 80 wt. %, up to about 75 wt. %, up to about 70 wt. %, up to about 65 wt. %, up to about 60 wt. %, or up to about 55 wt. % solvent. In some examples, the impregnation composition may comprise from about 50 wt. % to about 95 wt. % solvent, for example, about 55 wt. % to 95 wt. % solvent, for example, about 60 wt. % to about 90 wt. %, about 65 wt. % to about 85 wt. %, or about 70 wt. % to about 75 wt. % solvent.

In some examples, the impregnation composition may comprise up to about 40 wt. % non-volatile solids (NVS) (e.g., a combination of the epoxy resin and the curing agent), for example, up to about 35 wt. %, up to about 30 wt. %, up to about 25 wt. %, up to about 20 wt. %, up to about 15 wt. %, up to about 10 wt. %, or up to about 5 wt. % NVS. In some examples, the impregnation composition may comprise at least about 5 wt. % NVS, for example, at least about 10 wt. %, about 15 wt. %, about 20 wt. %, about 25 wt. %, about 30 wt. %, about 35 wt. %, or about 40 wt. % NVS. In some examples, the impregnation composition may comprise from about 5 wt. % to about 40 wt. % NVS, for example, about 10 wt. % to about 35 wt. %, about 15 wt. % to about 30 wt. %, or about 20 wt. % to about 25 wt. % NVS.

In some examples, the ratio of epoxy resin to curing agent may be calculated such that the ratio of epoxide functional groups in the epoxy resin to the reactive groups in the curing agent (e.g., amine functional groups or amide functional groups) may be from about 1.5:1 (i.e., about 1.5 to about 1) to about 1:1.5 (i.e., about 1 to about 1.5), for example, about 1.4:1 to about 1:1.4, about 1.3:1 to about 1:1.3, about 1.2:1 to about 1:1.2, or about 1.2:1 to about 1:1.

In some examples, the impregnation composition may be contacted with the base filter medium by any suitable process. In some examples, the impregnation composition may be contacted with the base filter medium by roller coating (e.g., kiss coating or double kiss coating), curtain coating, gravure coating, flexography coating, offset coating, reverse offset coating, or a combination thereof. In some examples, the impregnation composition may be contacted with the base filter medium from both surfaces of the base filter medium simultaneously or sequentially. In some examples, the impregnation composition may be contacted with the base filter medium by roller coating. In some examples, the impregnation composition may be contacted with the base filter medium by double kiss coating.

In some examples, the base filter medium may comprise a first surface and a second surface, the first surface opposing the second surface. In some examples, one surface of the base filter medium may be impregnated with the impregnation composition. In some examples, both surfaces of the base filter medium may be impregnated with the impregnation composition. In some examples, the method may comprise impregnating the base filter medium on both surfaces (i.e., the first surface and the second surface) by contacting both surfaces of the base filter medium with the impregnation composition. In some examples, the cured epoxy resin may impregnate the full thickness of the base filter medium. In some examples, the cured epoxy resin may impregnate one or both surfaces of the base filter medium but may not have penetrated into the center of the base filter medium.

In some examples, the method may comprise impregnating the base filter medium symmetrically or asymmetrically. As used herein, asymmetrically impregnating the base filter medium may refer to impregnating the base filter medium with two different impregnation compositions. In some examples, impregnating the base filter medium may comprise impregnating a first surface of the base filter medium with a first impregnation composition, and impregnating a second surface of the base filter medium with a second impregnation composition. In some examples, the first impregnation composition may comprise an impregnation composition of the type described herein. In some examples, both the first impregnation composition and the second impregnation composition may comprise an impregnation composition of the type described herein. In some examples, the first impregnation composition may be the same as or different from the second impregnation composition. In some examples, the first impregnation composition may be different from the second impregnation composition and the first impregnation composition and the second impregnation composition may both be impregnation compositions of the type described herein (that is, they may differ in, for example, concentration of the epoxy resin and/or the curing agent; in the chemical structure of the epoxy resin and/or of the curing agent; and/or in the additives included in the impregnation composition). In some examples, only one of the impregnation compositions (e.g., the first impregnation composition) may be an impregnation composition of the type described herein.

In some examples, at least one of the two impregnation compositions may penetrate the base filter medium by at least half and at most three quarters of the thickness thereof. In some examples, each of the impregnation compositions may penetrate the base filter medium by at least half and at most three quarters of the thickness thereof. In some examples, the impregnation composition may penetrate the full thickness of the base filter medium.

The method may further comprise reacting the epoxy resin with the curing agent to form the cured epoxy resin. In some examples, the epoxy resin may react with the curing agent at room temperature (for example, from about 20° C. to about 25° C.). In some examples, reacting the epoxy resin with the curing agent may comprise removing the solvent from the impregnation composition. In some examples, the method may comprise impregnating the base filter medium with an impregnation composition (that may comprise an epoxy resin, a curing agent, a solvent, and optionally an additional additive or additives) and inducing reaction of the epoxy resin with the curing agent, for example, by removing the solvent, to form a cured epoxy resin. In some examples, the cured epoxy resin may comprise a cross-linked matrix of the epoxy resin and the curing agent. In some examples, inducing reaction of the epoxy resin with the curing agent may comprise heating. In some examples, heating may accelerate the reaction of the epoxy resin with the curing agent.

In some examples, the method of producing a filter medium may comprise impregnating a base filter medium with an impregnation composition to form a base filter medium impregnated with the impregnation composition; drying the base filter medium impregnated with the impregnation composition to remove the solvent; and reacting the epoxy resin with the curing agent to form a cured epoxy resin. In some examples, drying the base filter medium impregnated with the impregnation composition may comprise heating. In some examples, drying the base filter medium impregnated with the impregnation composition may accelerate the reaction of the epoxy resin with the curing agent to form the cured epoxy resin. In some examples, drying the base filter medium impregnated with the impregnation composition may comprise heating to a temperature of up to 150° C., for example, up to about 140° C., up to about 130° C., up to about 120° C. In some examples, drying the base filter medium impregnated with the impregnation composition may comprise heating to a temperature of from about 50° C. to about 150° C., for example, about 100° C. to about 120° C. In some examples, drying the base filter medium impregnated with the impregnation composition may induce or accelerate the reaction of the epoxy resin with the curing agent.

In some examples, the method may further comprise reacting the diol with the epihalohydrin to form the epoxy resin. In some examples, the method of producing a filter medium may comprise reacting a diol with an epihalohydrin to form an epoxy resin and impregnating a base filter medium with the epoxy resin and a curing agent; and reacting the epoxy resin with the curing agent to form a cured epoxy resin, wherein the epoxy resin may comprise a diglycidyl ether formed by the reaction of a diol with an epihalohydrin; and wherein the epihalohydrin may be derived from renewable sources. In some examples, the method may comprise reacting a diol with an epihalohydrin to form an epoxy resin; combining the epoxy resin, a curing agent and a solvent (and optionally an additive or additives) to form an impregnation composition and impregnating a base filter medium with the impregnation composition; and reacting the epoxy resin with the curing agent to form a cured epoxy resin impregnated into the base filter medium.

In some examples, the method may further comprise producing an epihalohydrin from a renewable source, reacting the epihalohydrin with a diol to form an epoxy resin; impregnating a base filter medium with the epoxy resin and a curing agent; and reacting the epoxy resin with the curing agent to form a cured epoxy resin. In some examples, the method may comprise producing an epihalohydrin from a renewable source, reacting the epihalohydrin with a diol to form an epoxy resin, combining the epoxy resin, a curing agent and a solvent (and optionally an additive or additives) to form an impregnation composition; impregnating a base filter medium with the impregnation composition; and reacting the epoxy resin with the curing agent to form a cured epoxy resin.

In some examples, the epihalohydrin may be produced from any suitable renewable source. In some examples, the epihalohydrin may be produced from a plant product, such as rapeseed oil, coconut oil/fat, olive oil, palm oil or sunflower oil, or from an animal product such as animal fat.

### EXAMPLES

The examples and other implementations described herein are exemplary and not intended to be limiting in describing the full scope of materials, compositions, systems, and methods described herein. Equivalent changes, modifications, and variations of specific implementations, materials, compositions, systems and methods may be made within the scope of the implementations or embodiments described herein, with substantially similar results.

### Materials

### Epoxy Resin

EnviPOXY® 520: a bisphenol A diglycidyl ether epoxy resin produced from renewable epichlorohydrin and bisphenol A with an epoxy index of about 5.21 to about 5.5 mol/kg and an epoxy equivalent weight of about 182 to about 192 g/mol; available from Spolchemie®. EnviPOXY® 520 has a maximum renewable content of about 33.5 wt. % and a biobased carbon content of about 28 wt. % (as determined by ASTM 6866).

### Curing Agents

Polyamido amine: the product or reaction product of reacting a C18 fatty acid with triethylenetetramine with an amine number of about 300 to about 500 mg KOH/g.

Poly(amidoimidazoline)amine: a poly(amidoimidazoline)amine with an amine number of about 300 to about 500 mg KOH/g (typically about 390 mg KOH/g) and an imidazoline content of about 54 wt. %. The Poly(amidoimidazoline)amine had a biobased carbon content of about 75 wt. % (as determined by ASTM D6866-22 Method B (AMS) TOC).

### Solvent

### Methanol

### Base Filter Medium

A 100% cellulose (mainly pine tree) substrate with a basis weight of about 100 g/m² and a thickness of about 0.6 mm was used.

### Example 1

An impregnation composition was produced by combining about 10 wt. % EnviPOXY® 520, about 6.6 wt. % polyamido amine, and about 83 wt. % methanol. The impregnation composition was contacted with the base filter medium by a double kiss coating process. The base filter medium impregnated with the impregnation composition was heated to about 120° C. to remove the methanol and cure the epoxy resin. A filter medium impregnated with about 20 wt. % cured epoxy resin was produced.

### Example 2

An impregnation composition was produced by combining about 10 wt. % EnviPOXY® 520, about 6.6 wt. % poly(amidoimidazoline)amine, and about 83 wt. % methanol. The impregnation composition was contacted with the base filter medium by a double kiss coating process. The base filter medium impregnated with the impregnation composition was heated to about 120° C. to remove the methanol and cure the epoxy resin. A filter medium impregnated with about 20 wt. % cured epoxy resin was produced.

### SUMMARY

Impregnating the filter media with an impregnation composition formed from an epoxy resin derived from renewably sourced epichlorohydrin reduces the CO₂ emissions by from about 25 to about 30% for each filter medium produced. The physical properties of the filter media according to Examples 1 and 2 are shown in Table 1:

TABLE 1

| Properties | Units | Example 1 | Example 2 |
|---|---|---|---|
| Resin content | % | 19.10 | 19.80 |
| Bursting strength⁽¹⁾ | kPa | 468.00 | 505.00 |
| Air permeability⁽²⁾ | 1/m²s | 901.00 | 903.00 |
| Width related bending stiffness | cNmm | 369.12 | 407.55 |
| (15°, dry, MD)⁽³⁾ | | | |
| Width related bending stiffness | cNmm | 193.86 | 182.11 |
| (15°, dry, CD)⁽³⁾ | | | |
| Width related bending stiffness | cNmm | 41.12 | 41.86 |
| (15°, wet, MD)⁽³⁾ | | | |
| Width related bending stiffness | cNmm | 29.62 | 25.46 |
| (15°, wet, CD)⁽³⁾ | | | |
| Acetone extract 2 h | —% | 0.60 | — |
| Bursting strength after 24 h at 160° C.⁽¹⁾ | kPa | 332.00 | 352.00 |

⁽¹⁾by Mullen (7.3 cm² test area);
⁽²⁾at Δp 200 Pa;
⁽³⁾15 mm band size; MD: machine direction; CD: cross-direction.

While the present description has been described with reference to certain examples, those skilled in the art will appreciate that various modifications, changes, omissions, and substitutions can be made without departing from the spirit of the disclosure. It is intended, therefore, that the present description be limited by the scope of the following claims and their equivalents. Unless otherwise stated, the features of any dependent claim can be combined with the features of any of the other dependent claim and any of the independent claims.

What is claimed is:

1. A filter medium, comprising a base impregnated with a cured epoxy resin, wherein the cured epoxy resin comprises a diglycidyl ether comprising a diol and an epihalohydrin; and wherein at least the epihalohydrin is derived from a renewable source.

2. The filter medium of claim 1, wherein the cured epoxy resin is formed by the reaction of an epoxy resin with a curing agent.

3. The filter medium of claim 1, wherein the diglycidyl ether is formed by the reaction of the diol with the epihalohydrin.

4. The filter medium of claim 1, wherein the diol is bisphenol A, bisphenol F, or a mixture thereof.

5. The filter medium of claim 2, wherein the epihalohydrin is epichlorohydrin.

6. The filter medium of claim 1, wherein the cured epoxy resin comprises a biobased carbon content of at least about 20 wt %.

7. The filter medium of claim 1, wherein the cured epoxy resin comprises a biobased carbon content of from about 25 wt % to about 45 wt %.

8. The filter medium of claim 2, wherein the curing agent comprises one or more of poly(amido amine), poly(amidoimidazoline)amine, or a combination thereof.

9. The filter medium of claim 1, wherein the base comprises a paper substrate.

10. The filter medium of claim 1, wherein the base comprises cellulose fibers.

11. The filter medium of claim 1, wherein the diglycidyl ether is bisphenol A diglycidyl ether, bisphenol F diglycidyl ether, or a mixture thereof.

12. A filter comprising;
a frame; and
a filter medium disposed within the frame, wherein the filter medium comprises a base impregnated with a cured epoxy resin, wherein the cured epoxy resin comprises a diglycidyl ether comprising a diol and an epihalohydrin; and wherein at least the epihalohydrin is derived from a renewable source.

13. The filter of claim 12, wherein the filter medium is corrugated.

14. The filter of claim 12, wherein the cured epoxy resin is formed by the reaction of an epoxy resin with a curing agent.

15. The filter of claim 12, wherein the diglycidyl ether is formed by the reaction of the diol with the epihalohydrin.

16. The filter of claim 12 wherein the diol is bisphenol A, bisphenol F, or a mixture thereof.

17. A method of producing a filter medium, the method comprising:
impregnating a base filter medium with an epoxy resin and a curing agent; and
reacting the epoxy resin with the curing agent to form a cured epoxy resin, wherein the epoxy resin comprises a diglycidyl ether comprising a diol and an epihalohydrin, wherein the epihalohydrin is derived from a renewable source.

18. The method of claim 17, further comprising reacting the diol with the epihalohydrin to form the epoxy resin.

19. The method of claim 17, further comprising producing the epihalohydrin from rapeseed oil, coconut fat, olive oil, palm oil, sunflower oil, or animal fat.

20. The method of claim 17, further comprising contacting the epoxy resin, the curing agent, and a solvent to form an impregnation composition and contacting the base filter medium with the impregnation composition.
